(19) United States
(12) Patent Application Publication
(10) Pub. No.: US 2026/0284860 A1
(43) Pub. Date: Sep. 24, 2026

(54) TRANSMISSION BASE CANT HOOK

(71) Applicant: QUANTA ASSOCIATES, L.P., Houston, TX (US)

(72) Inventor: Bodie Faulks, Agency, MO (US)

(21) Appl. No.: 19/561,999

(22) Filed: Mar. 10, 2026

Related U.S. Application Data
(60) Provisional application No. 63/776,812, filed on Mar. 24, 2025.

(51) Int. Cl. B25J 1/04; B25G 1/12

(52) U.S. Cl. CPC B25J 1/04; B25G 1/12

(57) ABSTRACT

The disclosure relates to a cant hook for setting and positioning a suspended transmission base, having a first jaw piece; a second jaw piece pivotable towards and away from the first jaw piece, and wherein a length of the second jaw piece is adjustable; a first pin connected to the first jaw piece, and extending below or above the first jaw piece; a second pin connected to the second jaw piece and extending below or above the second jaw piece; wherein the first pin and the second pin are replaceable with a third pin and a fourth pin, and further wherein the third pin and the fourth pin are of different size from the first pin and the second pin.

### BACKGROUND

Technical Field: The disclosure relates to the field of setting, positioning and installing transmission bases, towers, and poles for electric, utilities, and/or communications infrastructure. A cant hook is a lever which may be used to move and manipulate logs or poles.

The installation of electric or utility transmission towers and bases conventionally requires multiple human operators to manually align a suspended transmission base into the final desired position on the foundation or ground. These transmission bases and towers can, on average, range from heights of 40 to 50 feet (or approximately 12 meters to 15 meters), with diameters of 5 to 9 feet (or 1.5 to 2.7 meters), and weigh in the range of 12,000 to 40,000 pounds (or 5,400 to 18,100 kilograms), and are often moving while suspended in mid-air. Manual handling of these large and heavy transmission bases can risk serious injury to operators and conventionally available cant hooks are incapable of handling the large sizes and weights associated with transmission towers. Additionally, removal or repair of transmission towers poses the same or similar risk. Therefore, a need exists an improved apparatus and method for setting large and heavy transmission bases which reduces the risk of injury to human operators, and eliminates manual handling of the transmission bases while providing the ability to easily position and guide these heavy structures into the desired setting locations.

### SUMMARY

The disclosure relates to a cant hook for setting and positioning a suspended transmission base, having a first jaw piece; a second jaw piece pivotable towards and away from the first jaw piece, and wherein a length of the second jaw piece is adjustable; a first pin connected to the first jaw piece, and extending below or above the first jaw piece; a second pin connected to the second jaw piece and extending below or above the second jaw piece; wherein the first pin and the second pin are replaceable with a third pin and a fourth pin, and further wherein the third pin and the fourth pin are of different size from the first pin and the second pin.

As used herein, the terms “transmission base”, “transmission structure”, “transmission structure base” and “structure bases” may be used to refer to any electric, utility or communication infrastructure tower, pole, or post.

### BRIEF DESCRIPTION OF THE DRAWINGS

The exemplary embodiments may be better understood, and numerous objects, features, and advantages made apparent to those skilled in the art by referencing the accompanying drawings. These drawings are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts an isometric front view of an exemplary embodiment of a transmission base cant hook.

FIG. 2 depicts an isometric rear view of an exemplary embodiment of a transmission base cant hook with a handle.

FIG. 3 depicts an isometric front view of the first jaw piece and the second jaw piece of an exemplary embodiment of a transmission base cant hook.

FIG. 4 depicts an isometric view of a pin for an exemplary embodiment of a transmission base cant hook.

FIG. 5 depicts a side view of an exemplary embodiment of a transmission base cant hook maneuvering a transmission base onto a foundation.

FIG. 6 depicts a side view of the exemplary embodiment of the transmission base cant hook of FIG. 5 aligning the transmission base onto the bolt cage on the foundation.

FIG. 7 depicts a side view of an exemplary embodiment of a transmission base cant hook with a handle, as used by an operator to maneuver a transmission base.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

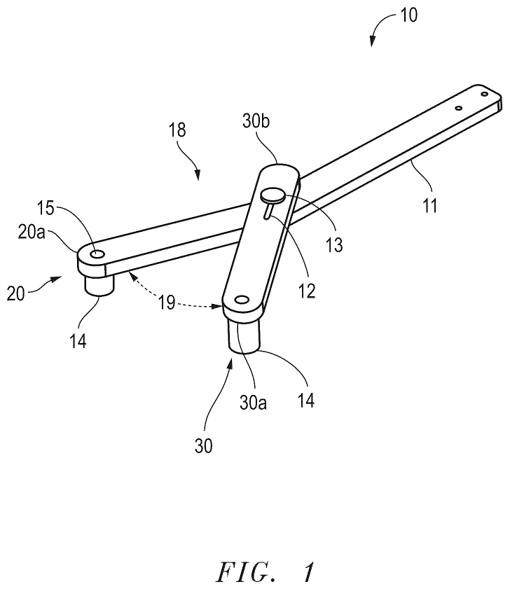

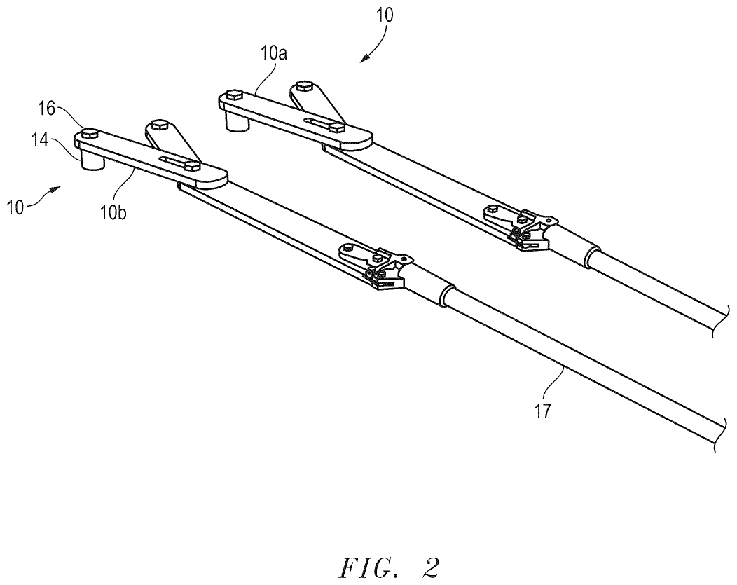

FIG. 1 depicts an isometric front view of an exemplary embodiment of a cant hook or transmission base cant hook 10. FIG. 2 depicts an isometric rear view of an exemplary embodiment of a transmission base cant hook 10 with a handle 17. The cant hook 10 may have a first arm or first jaw piece 20 as connected to a second arm or second jaw piece 30. Each jaw piece 20, 30 defines a first end, 20a, 30a respectively, where a pin 14 may extend perpendicularly from the cant hook 10 and, in the depicted embodiments of FIGS. 1-2, may be secured on an underside 10b of the cant hook 10. In alternative exemplary embodiments, the pins 14 may instead be secured to the top side 10a of the cant hook 10. The second jaw piece 30 is also pivotably connected at a second end 30b of the second jaw piece 30 to the first jaw piece 20 via a fastener 13 inserted through a slot 12 defined in the second jaw piece 30 and connecting the first jaw piece 20. The slot 12 may have a length 12a. Thus the jaw pieces or arms 20, 30 may form a jaw 18 which can open and close at an adjustable jaw angle 19 between the first jaw piece 20 and the second jaw piece 30, and wherein a length of the second jaw piece 30 may be adjustable as well by the distance, amount, or length 12a. The desired length or extension of the second jaw piece 30 may be changed by adjusting the fastener 13 along the length 12a of slot 12. The slot 12 and fastener 13 allows the jaw pieces 20,30 to be adjusted to fit various types of and sizes of structure bases 40. The desired length or extension of jaw piece 30 and the desired jaw angle 19 may be set or locked into position by securing the fastener 13 to the first jaw piece 20 and second jaw piece 30. The securing or affixing of the fastener 13 prevents the inadvertent or accidental change of the jaw piece 30 length and angle 19 during operation of the cant hook 10.

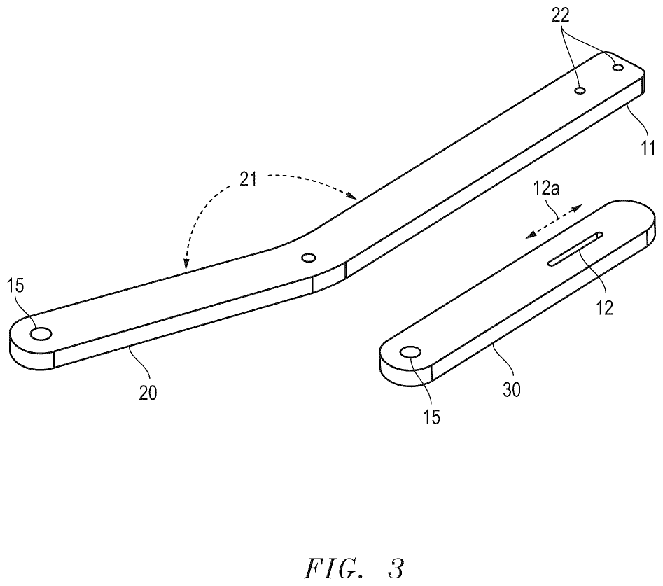

As shown at least in FIG. 3, the first jaw piece 20 may be unitary with a cant hook body 11. The first jaw piece 20 may be set, connected or joined at an angle 21 from the body 11 to accommodate average expected diameters of transmission bases or transmission structures 40. In certain exemplary embodiments, and by way of example only, this angle 21 may be approximately 160 degrees. In alternative exemplary embodiments, the first jaw piece 20 and second jaw piece 30 may be formed separate from the body 11 and subsequently attached to the body 11, wherein the first jaw piece 20 may also be pivotable or capable of adjusting the angle 21. The jaw pieces 20, 30 may be, in certain exemplary embodiments, be constructed of aluminum plate, although the scope of the disclosure encompasses alternative materials for same. The cant hook body 11 may be further connected to the handle 17 (see e.g. FIG. 2) via the openings 22 and fasteners. In alternative exemplary embodiments, the handle 17 may be unitary with the body 11. In yet further alternative exemplary embodiments, the handle 17 may be secured or connected to the body 11 via other attachments 22 as known to one of ordinary skill in the art. By way of example only, the handle 17 may be constructed of insulated fiberglass material for protection from hazardous touch potential, or other material which is nonconductive. The handle 17 may also be interchangeable to allow for further protection, depending on potential fault currents and as based on factors such as induction due to energized lines being in the vicinity. Conventionally, operators grabbed the tower structures 40 by hand and had no protection from induced voltage. The cant hook 10, including the handle 17, may be relatively light weight-by way of example only, in certain exemplary embodiments, the cant hook 10 may weigh approximately 18 pounds (or 8.2 kilograms).

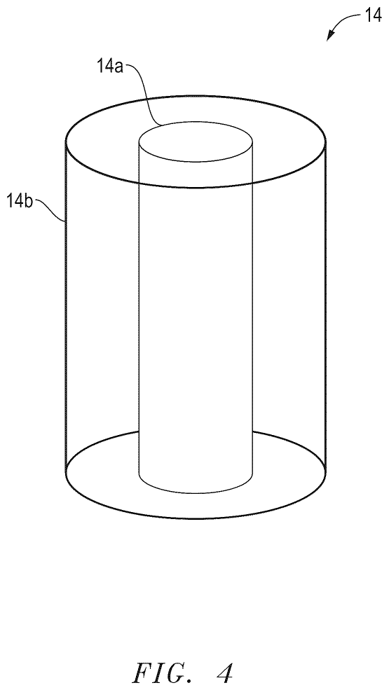

A pin 14 may be secured onto each end 20a and 30a of the jaw pieces 20 and 30 respectively, and extend vertically (or perpendicularly) from the cant hook 10. Each ends 20a, and 30a may have a fastener or bolt opening 15 defined through the jaw piece 20, 30 respectively which may be threaded. As may be best seen in FIG. 4, each pin 14 may be substantially tubular in shape, and may define an interior surface or bore 14a which may also be threaded and an exterior surface 14b. Although pin 14 is depicted as having a cylindrical exterior surface 14b with a circular cross section interior 14a, other shapes or cross sections of the exterior surface 14b are included within the scope of this disclosure, such as, and not to be limited to: hexagonal, square, or polygonal shapes. A bolt or fastener 16 may be inserted through each of the openings 15 through the top surface 10a of the cant hook 10 and into the interior surface or bore 14a of each pin 14, securing the pins 14 to the underside or bottom surface 10b of the cant hook 10. In alternative exemplary embodiments, the bolt or fastener 16 may be on the underside 10b, and the pin 14 may be on the top surface 10a of the jaw pieces 20, 30 of the cant hook 10. If a smaller or larger size or exterior surface 14b, or different shape of exterior surface 14b, of pin 14 is desired, the pins 14 may be removed, exchanged and/or replaced as needed for base flange openings 42 size by unfastening the pins 14 from the cant hook 10. The ability to swap or change out the pins 14 that are threaded via surface 14a and installed with a bolt 16 provides broad versatility for the cant hook 10 depending on the size of transmission structure 40 being set or placed onto the bolt cage 44.

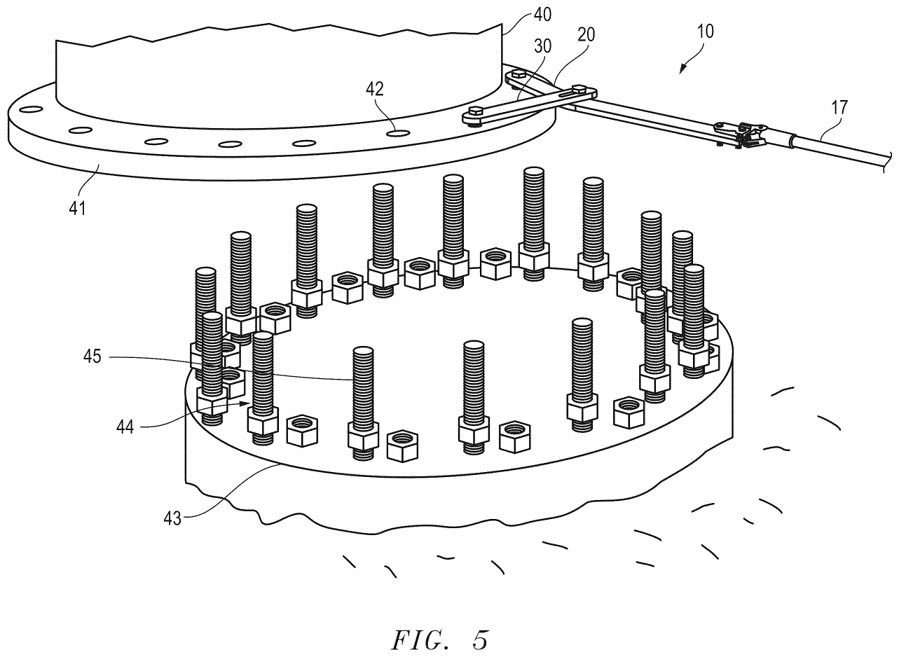

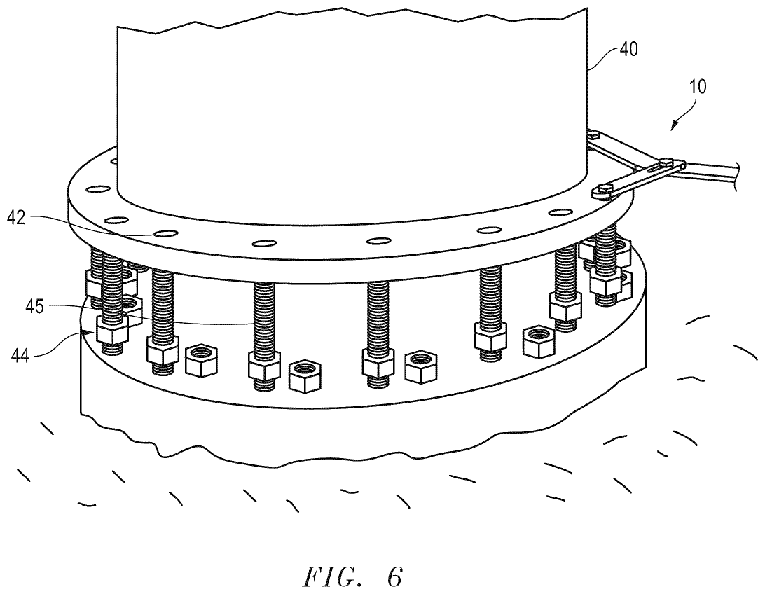

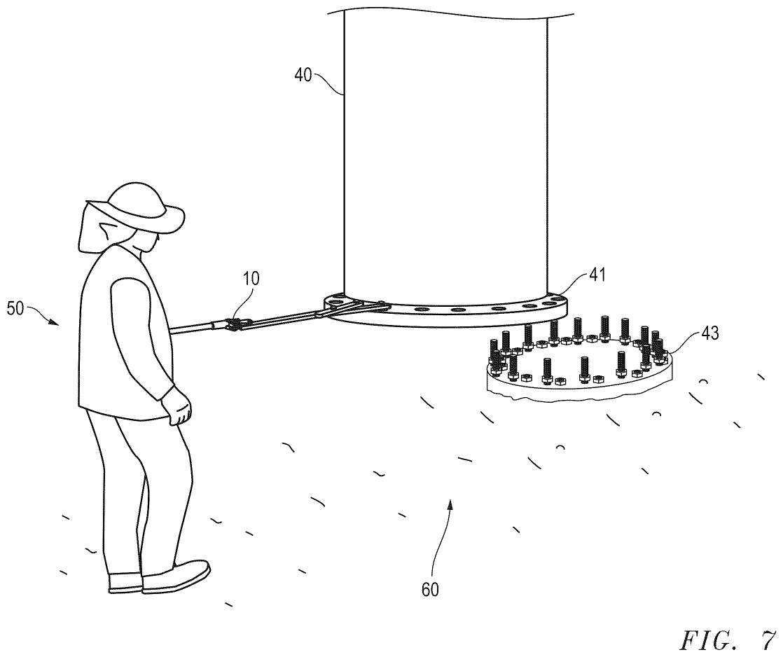

The positioning of the transmission base 40 via the cant hook 10 is depicted in FIGS. 5-7, wherein FIG. 5. depicts a side view of an exemplary embodiment of a transmission base cant hook 10 maneuvering a transmission base 40 onto a foundation 43; FIG. 6 depicts a side view of the exemplary embodiment of the cant hook 10 of FIG. 5 aligning the transmission base 40 onto the bolt cage 44 on the foundation 43; and FIG. 7 depicts a side view of an exemplary embodiment of a transmission base cant hook 10 with a handle 17, as used by an operator 50 to maneuver the transmission base 40 over the ground or other surface 60. The transmission base 40 defines a flange or flanged end 41, wherein the flange 41 has a plurality of openings or holes 42 defined on the flange 41. In order to install the transmission base 40, the openings 42 need to be aligned with, and then inserted onto the bolt cage members or bolts 45 of a bolt cage 44 as embedded or set into a foundation 43. After inserting all of the flange openings 42 into each member 45 of the bolt cage 44, the transmission base 40 can proceed with installation.

To use the cant hook 10 for moving the transmission base 40, the second jaw piece 30 is set to the desired length and the desired angle 19 via adjusting the fastener 13 in slot 12 to accommodate the transmission base 40 size and the distance between the openings 42 of the flange 41. The second jaw piece 30 is then fixedly attached or locked into position with the first jaw piece 20 via securing or tightening fastener 13. A desired size or exterior surface 14b of the pins 14 is selected to accommodate the size of the openings 42 on the flange 41 and to adequately support any movement, guiding, positioning, and potential spinning or clocking of the base 40. The pins 14 are then secured to the underside 10b or top surface 10a of each end 20a, 30a of the jaw pieces 20, 30, respectively, via bolts 16 inserted into the openings 15 and threaded interior surface 14a. The cant hook 10, if without handle 17, is attached to a handle 17 via fasteners in openings 22, or other attachments or connections 22 as known to one of ordinary skill in the art.

While the transmission base 40 is suspended, such as via a crane, each pin 14 is inserted into an opening 42 of the flange 41. The operator 50 can then use the handle 17 of the cant hook 10 to guide the transmission base 40 towards the desired location, such as the foundation 43 or other location 60, without manual or direct handling or touching of the transmission base 40 (see e.g., at least, FIGS. 5 & 7). The cant hook 10 also enables the operator 50 to safely perform minute adjustments, including clocking or spinning of the base 40 (or preventing spinning or clocking of same, if undesired), for precise alignment of the multiple openings 42 of the flange 41 with the many members 45 of the bolt cage 44 extending from the foundation 43. Conventionally, the alignment process between the multitude of flange openings 42 and the bolt cage 44 is a time-consuming and hazardous task to accomplish via manual manipulation of the heavy base 40, especially as the base 40 may experience spinning and/or swinging motion while in midair suspension. The conventional process of setting a transmission base 40 also often requires multiple human operators 50, thus potentially putting multiple lives at risk. The cant hook 10 enables a single operator 50 to safely position and set the transmission base 40 via positive control of the base 40 without directly handling or touching the base or structure 40.

While the embodiments are described with reference to various implementations and exploitations, it will be understood that these embodiments are illustrative and that the scope of the inventive subject matter is not limited to them. Many variations, modifications, additions, and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A cant hook for setting and positioning a suspended transmission base, comprising
a first jaw piece;
a second jaw piece pivotable towards and away from the first jaw piece, and wherein a length of the second jaw piece is adjustable;
a first pin connected to the first jaw piece, and extending below or above the first jaw piece;
a second pin connected to the second jaw piece and extending below or above the second jaw piece;
wherein the first pin and the second pin are exchangeable with a third pin and a fourth pin, and further wherein the third pin and the fourth pin are of different size from the first pin and the second pin.

2. The cant hook of claim 1, further comprising a first fastener configured for locking and unlocking the second jaw piece into position with the first jaw piece.

3. The cant hook of claim 2, further comprising a slot defined on the second jaw piece, wherein the fastener is slidable within the slot for adjusting the length of second jaw piece.

4. The cant hook of claim 3, wherein the first pin and the second pin are each secured to the first jaw piece and the second jaw piece, respectively, by a second fastener inserted through the first jaw piece and the second jaw piece and into each of the first pin and the second pin, respectively.

5. The cant hook of claim 4, wherein the first pin and the second pin are at a first end of the first jaw piece and the second jaw piece, respectively; and wherein the second jaw piece is pivotably connected to the first jaw piece towards a second end of the second jaw piece at the first fastener.

6. The cant hook of claim 1, further comprising a body of the cant hook, wherein the body of the cant hook is unitary with the first jaw piece, and wherein the first jaw piece is angled from the body of the cant hook.

7. The cant hook of claim 6, further comprising a first nonconductive handle attached to the body of the cant hook, wherein the first nonconductive handle is exchangeable with a second nonconductive handle having different conductivity properties than the first nonconductive handle.

8. A method for setting and positioning a suspended transmission base with a cant hook, comprising the steps of
inserting a first pin of the cant hook into a first opening defined on a flange of the suspended transmission base;
inserting a second pin of the cant hook into a second opening defined on the flange of the suspended transmission base; and
wherein the first pin and the second pin each extend from a first jaw piece of the cant hook and a second jaw piece of the cant hook, respectively, and wherein the first jaw piece is locked into position with the second jaw piece.

9. The method of claim 8, further comprising the step of adjusting a jaw angle between the first jaw piece and the second jaw piece.

10. The method of claim 9, further comprising the step of adjusting a length of the second jaw piece.

11. The method of claim 10, further comprising the steps of replacing the first pin with a third pin of different size from the first pin; and replacing the second pin with a fourth pin of different size from the second pin.

12. The method of claim 11, further comprising the steps of guiding the suspended transmission base towards a foundation; aligning and inserting the first opening and the second opening onto a first cage member and a second cage member, respectively, of a bolt cage embedded in the foundation.

13. The method of claim 12, further comprising the step of connecting a nonconductive handle to the first jaw piece and the second jaw piece.

14. The method of claim 13, further comprising the step of spinning the suspended transmission base via the first jaw piece and the second jaw piece.

15. The method of claim 14, wherein the steps of
(a) guiding the suspended transmission base towards the foundation;
(b) aligning and inserting the first opening and the second opening onto the first cage member and the second cage member, respectively, of the bolt cage embedded in the foundation; and
(c) spinning the suspended transmission base via the first jaw piece and the second jaw piece;
are accomplished via the step of operating the cant hook alone.

16. An apparatus for setting and positioning a suspended transmission base comprising:
a body unitary with a first jaw piece;
a second jaw piece pivotably connected to the first jaw piece via a slot defined in the second jaw piece;
a fastener for locking the first jaw piece to the second jaw piece into position;
an adjustable jaw angle defined between the second jaw piece and the first jaw piece;
wherein a length of the second jaw piece is adjustable via the slot and the fastener;
a pair of pins, wherein each pin in the pair of pins extends from an end of the first jaw piece and the second jaw piece; and wherein the pins are removable and replaceable from the first jaw piece and the second jaw piece; and
a nonconductive handle secured to the body.

17. The apparatus of claim 16, further comprising a pair of bolts inserted through the first jaw piece and the second jaw piece, into the pair of pins.

18. The apparatus of claim 17, wherein an interior surface defined in each of the pair of pins are threaded.

19. The apparatus of claim 18, wherein the body, the first jaw piece, and the second jaw piece are constructed of aluminum plate.

20. The apparatus of claim 19, wherein the nonconductive handle is exchangeable with a second nonconductive handle based on an expected fault current.
